(19) United States
(12) Patent Application Publication
(10) Pub. No.: US 2026/0067518 A1
(43) Pub. Date: Mar. 5, 2026

(54) CONTENT PREPROCESSING

(71) Applicants: Beijing Zitiao Network Technology Co., Ltd., Beijing (CN); Lemon Inc., Grand Cayman (KY)

(72) Inventors: Wei HE, Beijing (CN); Zhendong ZHONG, Beijing (CN); Aoyang ZHANG, Beijing (CN); Pengcheng CHEN, Beijing (CN); Shenglan HUANG, Culver City, CA (US); Qianpen WANG, Beijing (CN); Xiaolei LI, Beijing (CN); Chao MA, Beijing (CN); Mingkui LIU, Culver City, CA (US); Qian MA, Beijing (CN); Haiqing TAO, Beijing (CN); Baowang CHI, Beijing (CN)

(21) Appl. No.: 19/319,496

(22) Filed: Sep. 4, 2025

(30) Foreign Application Priority Data
Sep. 5, 2024 (WO) PCT/CN2024/117278

(51) Int. Cl. H04N 21/262; H04N 21/238; H04N 21/24; H04N 21/414; H04N 21/433

(52) U.S. Cl. CPC H04N 21/262; H04N 21/238; H04N 21/2407; H04N 21/41407; H04N 21/433

(57) ABSTRACT

Methods, systems, and apparatus, including computer programs encoded on computer storage media, for content preprocessing. One of the methods includes determining, for a first set of digital content to be provided to a user device, (i) whether to establish network connections for obtaining data of the first set and (ii) a connection time indicating when to establish the network connections; establishing each of the network connections at the respective connection time; determining, for a previously stored set of digital content, (i) pre-processing operations for an item of the previously stored set of digital content and (ii) a pre-processing time indicating when to perform the pre-processing operations on the previously stored item; and providing one or more pre-processed items of the previously stored set of digital content to the user device.

### CROSS-REFERENCE TO RELATED APPLICATION(S)

This application claims priority to PCT Application No. PCT/CN2024/117278 filed in Sep. 5, 2024, the disclosure of which is incorporated herein by reference in its entity.

### BACKGROUND

Online platforms provide content, including video content, to a user. Before being displayed on a user device, the content can be obtained from another source, such as a server. Obtaining content in preparation for viewing can be referred to as loading.

### SUMMARY

This specification describes technologies for content preprocessing. In some cases, techniques include scheduling and performing pre-processing operations, such as preloading and prerendering, for multimedia content to reduce latency in providing the multimedia content to a user device. Techniques improve content latency and processing loads by; e.g., decomposing various preprocessing stages into discrete operations that can be separately determined and performed to optimize available resources at any given time.

In general, one aspect of the subject matter described in this specification can be embodied in methods that include the actions of determining, for a first set of digital content to be provided to a user device, (i) whether to establish network connections for obtaining data of the first set and (ii) a connection time indicating when to establish the network connections: establishing each of the network connections at the respective connection time: determining, for at least a portion of the first set of digital content. (i) whether to preload an item of the first set of digital content using an established network connection and (ii) a preloading time indicating when to preload the digital content item: preloading one or more items of the first set of digital content using an established network connection at the respective preloading time: determining, for a previously stored set of digital content. (i) pre-processing operations for an item of the previously stored set of digital content and (ii) a pre-processing time indicating when to perform the pre-processing operations on the previously stored item, wherein the previously stored set of digital content includes the preloaded one or more items of the first set of digital content; and providing one or more pre-processed items of the previously stored set of digital content to the user device.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. Feature 1: Establishing each of the network connections at the respective connection time comprises: establishing a data transfer channel between the user device and a data source, wherein the data source includes a portion of the first set of digital content. Feature 2: Preloading one or more items of the first set of digital content at the respective preloading time comprises: storing header data of the first set of digital content in memory of the user device. Feature 3: Preloading one or more items of the first set of digital content at the respective preloading time comprises: storing a first frame of data from the first set of digital content in memory of the user device. Feature 4: Preloading one or more items of the first set of digital content at the respective preloading time comprises: storing a first set of data frames from the first set of digital content in memory of the user device. Feature 5: Determining one or more of the network connections, preloading of the one or more items, or the pre-processing operations comprises: obtaining data indicating user behavior; and determining, using the obtained data, one or more actions. Feature 6: Obtaining the data indicating user behavior comprises: obtaining data indicating a rate of content requests by the device, and wherein determining the one or more actions comprises: determining, using the obtained data indicating the rate of content requests, to establish the network connections. Feature 7: Obtaining the data indicating the rate of content requests by the device comprises: obtaining data indicating a swipe speed of a user controlling the device. Feature 8: Determining to establish the network connections using the obtained data indicating the rate of content requests comprises: determining a first amount of network connections for data indicating a first rate of content requests and a second amount of network connections for data indicating a second rate of content requests, wherein the first amount of network connections is greater than the second amount of network connections, and wherein the first rate of content requests is greater than the second rate of content requests. Feature 9: Actions include determining an estimated consumption time of content playing on the user device, wherein determining (i) whether to preload an item of the first set of digital content using an established network connection or (ii) a preloading time indicating when to preload the digital content item comprises: comparing the estimated consumption time with a remaining consumption time; and determining, using the comparison. (i) whether to preload an item of the first set of digital content using an established network connection or (ii) a preloading time indicating when to preload the digital content item. Feature 10: Determining (i) the pre-processing operations for an item of the previously stored set of digital content or (ii) a pre-processing time indicating when to perform the pre-processing operations on the previously stored item comprises: determining whether to perform predemuxing separate from prerendering. Feature 11: Determining whether to perform predemuxing separate from prerendering comprises: obtaining context data; and determining, using the context data, whether to perform predemuxing separate from prerendering. Feature 12: Obtaining the context data comprises: obtaining an indication of processing bandwidth of the user device, and wherein determining whether to perform predemuxing separate from prerendering comprises: determining, using the indication of processing bandwidth of the user device, whether to perform predemuxing separate from prerendering.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. For example, by decomposing preprocessing stages and individualizing determination and scheduling of those preprocessing stages, the techniques can optimize for available bandwidth to reduce latency and reduce instantaneous load, e.g., that can result in frame drops or hardware damage, such as damage caused by processor overheating. Techniques can optimize a first frame of a video and reduce power requirements on devices, e.g., devices with less advanced processing resources resulting in decreased performance compared to devices with more advanced processing resources or devices currently at low battery levels which may reduce performance in an attempt to extend battery life.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example platform system.

FIG. 2 shows an example of a system for content preprocessing.

FIG. 3 is a flowchart of an example process for content preprocessing.

FIG. 4 is a block diagram of a computing system that can be used in connection with computer-implemented methods described in this specification.

Like reference numbers and designations in the various drawings indicate like elements.

### DETAILED DESCRIPTION OF EMBODIMENTS

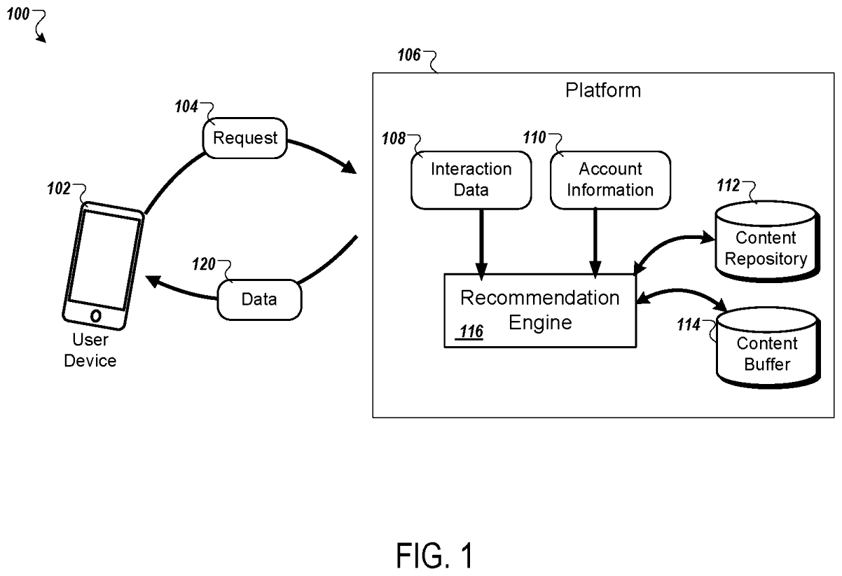

FIG. 1 shows an example platform system 100. The system 100 can provide content, such as user-specific content, to the user device 102 in response to a received request 104. The request can be sent by the user device 102 in response to a user opening an application, e.g., running on the user device 102, or interacting with an ongoing instance of an application.

The system 100 includes a user device 102 and a platform 106. The user device 102 can be a mobile computing device, such as a smartphone. The platform 106 can operate on the user device 102, one or more computers external to the user device-such as servers, distributed networks, or the like- or a combination of one or more of these. The platform 106 can operate on one or more processors configured to perform operations described in reference to the platform 106 of FIG. 1.

The user device 102 sends the request 104 to the platform 106. In cases where the platform 106 is external to the user device 102, the request 104 can be sent over a suitable data network, such as Wi-Fi, 5G, or Ethernet, from the user device 102 to the platform 106. In some cases, the platform 106 can use suitable networks to provide data between two or more elements of the platform 106. In some cases, the user device 102 sends the request 104 to the platform 106 operating internally using processors and connected components of the user device 102.

Each user device, such as the user device 102, can be configured with software that in operation can access a streaming service, e.g., of the platform 106. A user can interact with the streaming service using a device. For example, the device can use software to upload video content to the streaming service as well as receive videos from the streaming service. The software can be a specific application of the streaming service installed on the device. The streaming service can be, for example, an online social media platform.

In some implementations, the software provides a user interface for interacting with the streaming service. The user interface can include receiving data from the streaming service for presenting a feed of videos that the user can interact with. For example, the user can scroll up or down to switch between videos in the feed as well as interact with individual videos, e.g., by posting comments about the video, sharing the video, or expressing approval, e.g., liking the video.

In some implementations, the video content provided by the streaming service to user devices are short-form videos. Short-form videos are videos that are typically less than 90 seconds in length. In some implementations, short-form videos have lengths of between 15 and 90 seconds. By contrast, long-form videos typically have lengths of at least 3 minutes.

The platform 106 receives the request 104. The request 104 can include a request for specific content, such as a specific video or content page, or a general request (e.g., to present a video feed). The platform 106 can generate and provide data 120 to be displayed on the user device 102.

In some cases, the platform 106 recommends specific content for a specific user, e.g., based on data associated with the user. For example, the platform 106 can include a recommendation engine 116. The recommendation engine 116 can determine content that is likely to be of interest to a user, e.g., that the user is likely to find useful or appealing. The recommendation engine 116 can use data associated with a user to determine content for a given user. In some cases, the recommendation engine 116 uses interaction data 108 and account information 110 to determine content for a given user. The interaction data 108 can include representations of one or more interactions taken by a user of the user device 102, e.g., using a graphical user interface displayed on the user device 102. The account information 110 can include information, such as demographic information, interests, or historical data associated with a user.

In the example of FIG. 1, the recommendation engine 116 uses the interaction data 108 and the account information 110 to generate and provide the data 120 to the user device. The recommendation engine 116 can include one or more machine learning models that have been trained to predict content that will be useful or appealing to a user—e.g., based on interaction or viewing duration metrics. The recommendation engine 116 can use training data that includes data associated with a user and an indication of whether or not recommended content resulted in positive or negative impacts on engagement, such as interaction or viewing duration metrics.

In some cases, one or more models of the recommendation engine 116 are trained online—e.g., using feedback from real users after devices of the real users have obtained recommended content from the recommendation engine 116. For example, the recommendation engine 116 can provide recommended content and the platform 106 can record subsequent actions by a user to determine if the recommended content was a good or bad recommendation where good can represent content that increases user engagement or is labeled by a user as helpful or appealing and bad can represent content that decreases user engagement or is labeled by a user as not helpful or appealing.

In some cases, the recommendation engine 116 provides data from a content repository 112 or a content buffer 114. For example, the content repository 112 can include content recorded by users of the platform 106, or other instances of the platform 106, and uploaded to servers associated with the platform 106. The content can include videos uploaded by users. The content repository 112 can be stored, at least partially, in memory of the user device 102. For example, the user device 102 can store content for offline viewing or content that the user uploaded.

The content buffer 114 can include content being provided to the user device 102. For example, content, such as live recordings made by users, can be uploaded to the platform 106, or other instances of the platform 106, e.g., as the content is being created. In the case of videos, the content can include frames of video uploaded for viewing. For live video, frames can be uploaded for viewing as they are captured by a recording device. The platform 106 can access content included in the content buffer 114 and provide the data to the user device 102. In some cases, the content buffer 114 is stored, at least partially, in memory of the user device 102. For example, the content buffer 114 can include loaded live or prerecorded data that will be shown on a display of the user device 102 at a particular time or in response to one or more specific interactions by a user of the user device 102, e.g., a swiping up motion on a touch screen. The content buffer 114 can include cache memory of the user device 102.

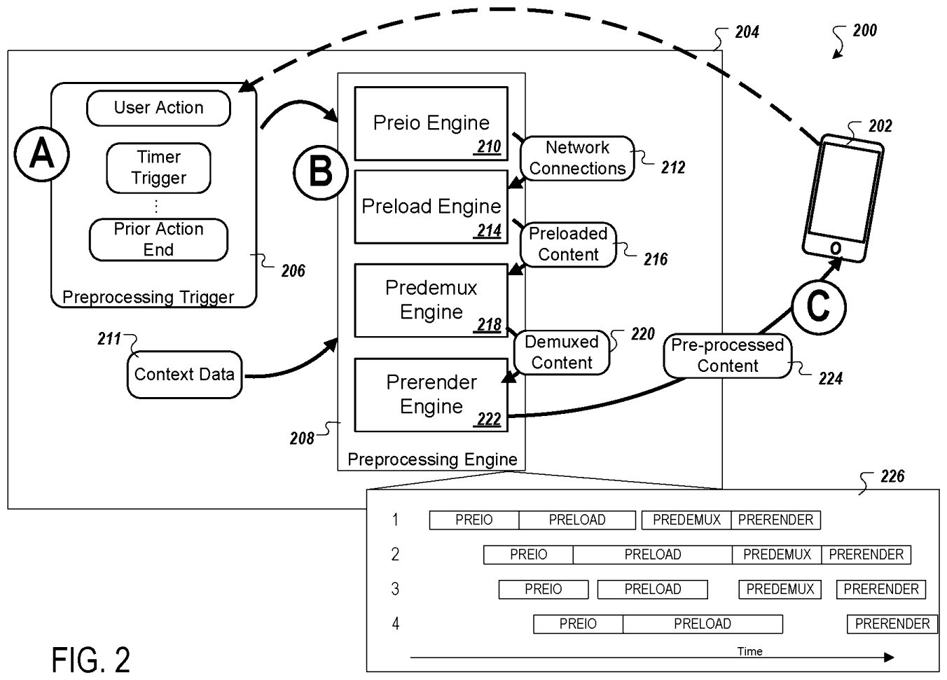

FIG. 2 shows an example of a system 200 for content preprocessing. The system 200 can preload content before the content is specifically requested for being viewed or consumed in a way that minimizes latency, such as first frame latency; for a user and bandwidth and processing of the system 200. The system 200 includes a user device 202 and a platform 204. The platform can be a version of the platform 106 of FIG. 1. The platform 204 can run at least partially using one or more processors of the user device 202.

The system 200 can be similar to the system 100 of FIG. 1 in that the user device 202 can send requests to the platform 204 as the user device 102 sends requests to the platform 106 described in reference to FIG. 1. The system 200 of FIG. 2 is used to show the techniques of content preprocessing that can be used by a system, such as the system 100.

The platform 204 can help reduce content latency: For example, content latency can include first frame latency which indicates the time between when a user requests content until the first frame of the content appears, where the content includes a video. For other forms of content, content latency can refer to a time between when a user requests content until a first portion of that content is provided to a device of the requesting user, such as a first second of audio.

The platform 204 can help reduce content latency by improving data preparation and data parsing. Data preparation can include establishing a network connection and transferring content to be provided to a user using the established network connection. Data parsing can include converting the prepared data into a format for user consumption, e.g., converting video data files into video and audio frames through processes such as de-multiplexing and decoding. Improving data preparation and data parsing can include performing data preparation and data parsing as early as possible while taking into account device capabilities and device context.

The techniques described in this specification can reduce content latency by using obtained input to determine, for one or more processing stages within data preparation or data parsing. (i) whether to perform the processing stage and (ii) when to perform the processing stage. The one or more processing stages can include preio, preload, pre-de-multiplex, prerender, or a combination of these among others. Preio can include establishing one or more connections to transfer content, e.g., from a content repository of the platform 204 to memory of the user device 202. Preload can include the transferring of content data via the established one or more connections. Pre-de-multiplex can include operations of prerendering, e.g., separating preloaded data into separate streams, such as video and audio. Prerender can include starting a player instance to provide preloaded content to a user. As discussed, a subset or all of these processing stages can be performed by the system 200 depending on determinations made by the system 200.

The processes shown in the example of FIG. 2 are described in stages A through C. In stage A, a preprocessing trigger 206 triggers content preprocessing. Examples of triggers include user actions, timers, processing operation started, processing operation completed (such as downloading completing), or a combination of these among others. In some cases, the user device 202 triggers content preprocessing, e.g., by obtaining user input via a touch screen. User actions can include swiping up or down on the screen to request a video. Timers can include preset timers, started before or after an event of the system 200, that, when the timer reaches a threshold time, trigger content preprocessing. Processing operations starting or completing can include processing stages of data preparation or data parsing.

The preprocessing trigger 206 can trigger content preprocessing to be performed by a preprocessing engine 208. The preprocessing engine 208 can include one or more engines, otherwise referred to as sub-engines. For example, the preprocessing engine 208 can include a preio engine 210, a preload engine 214, a predemux engine 218, and a prerender engine 222.

In stage B, the preprocessing engine 208 performs processes for content preprocessing. The preprocessing engine 208 can use context data 211 as input, e.g., to determine one or more operations to perform and when to perform them. The context data 211 can include user actions, network environment, device capacity, device identifier, content indicators (such as playlist status, video header size, first frame size), or a combination of these, among others. For example, the context data 211 can include current or historical actions performed using the device 202, such as swiping, navigation between content pages, an indication of a rate of requests (e.g., indicating fast or slow scrolling, based on speed thresholds indicating fast or slow), an indication of swipe direction (e.g., swipe upward or swipe downward), or a combination of these, among others.

The context data 211 can include user behavior prediction. User behavior can include short-term actions, such as fast or slow scrolling. Fast scrolling can indicate a scroll distance per unit of time that satisfies a threshold or an amount of content scrolled through per unit of time that satisfies a threshold. Slow scrolling can indicate a scroll distance per unit of time that satisfies a slow threshold or an amount of content scrolled through per unit of time that satisfies a slow threshold.

The context data 211 can include long-term consumption habits or preferences for certain content, e.g., types of videos. For example, a user can consume content characterized by one or more features which can indicate a habit or preference for content with those one or more features. The one or more features can include a topic, visual appearance, uploading user, length, or any other content characteristic.

The context data 211 can include predictions of a duration of content playback, such as video playback. For example, if current content is expected to be consumed, e.g., watched, for a longer duration, the preprocessing engine 208 will likely have more time to complete data preparation and parsing in advance of next content. The preprocessing engine 208 can determine to forgo one or more processing stages, or reduce the size or amount of processing in one or more processing stages, to reduce necessary processing bandwidth. Reducing bandwidth might be possible if current content is expected to be consumed for a longer duration because processing can be performed over a longer period of time, effectively reducing instantaneous processing bandwidth usage.

The context data 211 can include an indication of a network environment. For example, a network environment indicator can include an indication of strong or weak signal strength, e.g., signal from Wi-Fi or cellular networks. In general, better network connectivity can allow for data preparation to be completed in a shorter time without impacting data download of current content, e.g., a video currently being played. In some cases, in response to an indication of network environment, the preprocessing engine 208 can determine to perform one or more processing stages. For example, if the context data 211 indicates that a device is well connected—e.g., high data transfer bandwidth or speed—the preprocessing engine 208 can determine to preload additional data for subsequent content. Preloading additional data can help to enhance fault tolerance, e.g., of user behavior predictions. For example, if a user requests content more rapidly than expected, the additional preloading can help to reduce latency for the additional requested content.

The context data 211 can include a load indication. For example, a load indication can include whether or not a device is capable of high capacity processing or data transfer—e.g., whether the device is equipped with one or more processors that have been determined to satisfy a threshold capacity of processing or data transfer. A load indication can depend on the hardware of a device. A load indication can depend on the current load of the device, e.g., where additional tasks performed by the device can decrease available bandwidth and therefore decrease available load indicated by the load indication. In general, in response to a load indication that indicates high capacity: the preprocessing engine 208 can perform data processing in a shorter time without affecting a smoothness of current content, e.g., smoothness of current video or audio.

The context data 211 can include a playlist status. For example, a playlist status can indicate dependencies of processing stages determined or scheduled for a given content item. Dependencies can include performing preio prior to performing preloading. By using context data 211 that includes a playlist status, the preprocessing engine 208 can prevent a content item from, e.g., being preloaded prior to connections being established or rendering prior to loading.

The preio engine 210 can be configured to establish network connections 212. The network connections 212 can include input output interfaces for data. The preio engine 210 can establish a connection for transferring content for preloading. The content can be stored in a repository of the platform of the platform 204, e.g., the content repository 112 of FIG. 1. The preio engine 210 can establish connections using one or more wireless or wired protocols. Establishing connections can include sending a connection request to a computer managing a content repository in memory. In some cases, cryptographic keys can be generated or used for signing to establish an encrypted connection. In some cases, a transport layer security process, such as a handshake, is completed as a part of establishing one or more connections. Establishing connections can include a use of a domain name system (DNS), secure sockets layer/transport layer security handshake (SSL/TLS handshake), transmission control protocol handshake (TCP handshake), hypertext transfer protocol (HTTP), transmission control protocol (TCP), or a combination of these among others.

The preio engine 210 determines, for content to be provided to the device 202, whether to perform a preio operation and, if so, when to perform that operation. The preio engine 210 can use the context data 211 to determine whether or when to perform one or more operations for establishing the network connections 212.

For content, such as videos, that have not been stored in cache memory of the user device 202, establishing network connections for data transmission prior to a user requesting a start of content (e.g., by an action, such as scrolling or swiping) can reduce content latency: Establishing network connections can increase a smoothness of content playback and enhance a viewing experience. Preio can have relatively low latency and can be scheduled for the next N content items, such as videos, where N can be any number. The preio engine 210 can determine a number of content items for which to establish network connections using the context data 211.

If a number of connections is too high or the connections are maintained for too long, it can increase a load on both a client (such as the device 202) and a server (such as a server that stores content in the platform 204). There is a possibility that a connection can be disconnected during playback or preloading. The preio engine 210 can analyze at least a portion of the context data 211 and determine whether or when to establish connections. For example, the preio engine 210 can analyze user watching duration predictions for videos. The preio engine 210 can be determined to establish connections for videos that are anticipated to not be stored in cache memory—e.g., where content can be stored in cache based on previous viewing or user actions to save content.

The preio engine 210 can determine a number of content items for which to establish network connections. In some cases, the preio engine 210 can determine a number of content items based on a current content page viewed by a user. For example, content pages can include a feed page and non-feed page. A feed page can show content that is recommended to a user, e.g., based on viewing habits and a trained predictive model. A non-feed page can include a personal page that includes content uploaded by a particular user or account.

In some cases, the preio engine 210 can determine a number of content items based on user behavior. For example, if a user is scrolling quickly, the preio engine 210 can establish connections for more content items compared to when a user is scrolling slowly. In some cases, the preio engine 210 can compare scrolling behavior of a user to one or more thresholds indicating threshold behavior, such as a first scrolling speed of 1.2 content items per second or a second scrolling speed of 1000 pixels of content space per second. Based on comparing scrolling behavior obtained by the user device to one or more scrolling thresholds, the device 202 can determine whether or not a user is scrolling slowly or quickly. Similar thresholds can be used for other user behavior. In general, a rate indicating a number of content requests per unit of time can be used by the preio engine 210 to determine whether or not to establish connections for one or more content items.

In some cases, the preio engine 210 can determine to establish network connections for the next four content items in response to determining that a user is quickly scrolling on a feed page. In some cases, the preio engine 210 can determine to establish network connections for the next two content items in response to determining that a user is slowly scrolling on a feed page. Network connections might be different or the same for a given set of content items. For example, a same network connection can be used for content that is stored at a same memory location, e.g., on a server. In such cases, the preio engine 210 can generate a network connection for a content item that is the same as one or more other content items but is associated with a particular content item. In response to a content item being moved or updated, a network connection can be updated, e.g., by the preio engine 210.

In some cases, the preio engine 210 can determine to establish network connections for the next four content items in response to determining that a user is sliding downward on a non-feed page, such as a personal page. In some cases, the preio engine 210 can determine to establish network connections for the next two content items in response to determining that a user is sliding upward on a non-feed page. Specific values can be tuned to suitable values, e.g., based on AB testing performed on the platform 204.

In some cases, the preio engine 210 can adjust a base number of items for network connections. For example, based on one or more preloading parameters, the preio engine 210 can adjust how many network connections to generate for how many content items. In some cases, the preio engine 210 uses an historical preloading hit rate and a completion status of preloading. The historical preloading hit rate can indicate a rate of successful preloading—e.g., where preloaded content was provided to a user. In some cases, successful preloading can indicate preloading that was loaded for less than a threshold amount of time before being used—e.g., reducing the bandwidth. A completion status of preloading can indicate whether or not one or more content items have been loaded. An example expression that the preio engine 210 can generate is baseCount+ (1−historyPreloadRatio)*delta where bascCount can be given by thresholds of fast or slow scrolling or other data from the context data 211. The result of this expression can be referred to as prelinkCount. If all preloading tasks are completed at the end of viewed content, the number of content items for which to establish can connections be determined the by preio engine 210 using the expression: max (baseCount, prelinkCount−1). This result can be referred to as masPrelinkCount. If there is an unfinished preload task at the end of vv, the number of content items for which to establish connections can be determined by the preio engine 210 using the expression: min (maxPrelinkCount, prelinkCount+preloadNotFinishCount), the result of which can indicate a final prelink count result.

The preio engine 210 can determine a timing of establishing one or more network connections of the network connections 212. In some cases, preio is used as a fallback strategy for preloading. In some cases, intermediate decision results of preloading can be used as input by the preio engine 210 to determine whether subsequent content can be preloaded, e.g., to enable timely initiation of preio. Once current content starts playing, the preio engine 210 can perform a check on a cache status of a next content item. Based on the context data 211, e.g., a status of one or more videos in a playlist, the preio engine 210 can generate a prediction indicating whether upcoming content that has not been cached can be preloaded before playback. If preloading is not possible, preio can be initiated for the subsequent content. If preloading is possible, the preio engine 210 can perform preio and preloading processing for that content. By separating the processes, and performing all pre-processing as soon as can be managed based on elements of the context data 211, the system 200 can help to reduce latency:

In some cases, the preio engine 210 performs one or more operations after a first content is provided to the device 202 or on startup of an application for providing content. The operations can be used to determine whether to start preio for a given content item at a given time. Operations can include operations represented in the following pseudocode:

```
                Video Starts :
              if ‘Buffer Mode’ :
          if Play Task Downloading :
        if buffer > preloadSafeThreshold :
    if remainPlayTaskDownloadTime > remainWatchTime :
                  shouldPrelink = True
                          else:
                shouldPrelink = False
                        else :
if MaxDownloadSize / playBitrate − estPlayTime + buffer >
              preloadSafeThreshold:
                    shouldPrelink = False
                          else:
                    shouldPrelink = True
    else if Preload Task Downloading :
              shouldPrelink = False
                      else :
              shouldPrelink = False
            else if ‘Cache Mode’ :
          if Next Video not Cached :
                shouldPrelink = True
                        else:
              shouldPrelink = False
```

Briefly, the preio engine 210 can determine whether or not a next content item, in this case a video, is stored in cache memory. If the next video is not cached, the preio engine 210 can determine to establish a connection for that content item, e.g., at the moment of this determination. In some cases, a determination of count can be used to determine how many content items the system 200 will perform the described operations on, e.g., in preparation for those content items being provided to a user device. If the next video is cached, the preio engine 210 can determine not to establish connections (also referred to as prelink) for the given content item. “Buffer Mode” can indicate instances where content being played is not fully cached. “Cache Mode” can indicate instances where content being played is fully cached. The system 200 can use a determination of these modes to perform operations represented in the above pseudocode.

The preload engine 214 uses the network connections 212 to preload content and generate the preloaded content 216. Similar to the preio engine 210, the preload engine 214 can use at least a portion of the context data 211 to make one or more determinations. In this case, the preload engine 214 can use the context data 211 to determine whether or when to preload content using one or more of the network connections 212.

In some cases, preloading can reduce connection establishing time and completion time of processing prior to content being ready for consumption. This improvement can be especially significant in poor network conditions (e.g., indicated by the context data 211) or if a cache hit rate is low due to user behavior, such as fast scrolling behavior. Cache hit rate can refer to a rate of content being available in a buffer (such as cache memory) when that content is provided, e.g., on a display or speaker of a user device. When a user is requesting content rapidly, e.g., by fast scrolling, the platform 204 might prevent system overload by not storing a portion of such requested content in cache memory. Because such data is not being stored in cache memory, the cache hit rate can be low: In some cases, preloading includes preio operations. For example, if the preload engine 214 determines to preload one or more content items, and preio processes have not been performed for those one or more content items, the preload engine 214 can provide a request to the preio engine 210 instructing the preio engine 210 to establish one or more connections for the one or more content items. Preio might not be performed in certain cases, such as a first feed stream in a cold start or scene switch, or content items that are expected to trigger preloading. A scene switch can refer to a process of switching from one virtual content area to another virtual content area, such as from one page in a video streaming application that supports playing video content to another page in the application that also supports playing video content. The system 200 can determine content items that are expected to trigger preloading by using a cache buffer of currently playing content. If the system 200 determines that a buffer is sufficiently large to accommodate additional data for an additional content item, the system 200 can preload the additional content item. If the system 200 determines that a buffer is not sufficient large, the system 200 can not preload or wait until buffer space is available for preloading the additional content item.

In some cases, the preload engine 214 can determine an amount of data, for a given content item, to preload. The preload engine 214 can determine to preload more data when bandwidth is available or when user behavior, e.g., included in the context data 211, indicates that subsequent consumption will be limited to a smaller group of content. The preload engine 214 can use various forms of available data to determine how much data of a given content item to preprocess. The preload engine 214 can select an amount of data to preload from among a set of predefined amounts, e.g., a header, a first frame, or a first two frames. For example, there can be N levels, where N can be any suitable number, of content preprocessing, where each level indicates a different amount of data. A first level of the N levels can indicate a header of a content item to be parsed. A second level of the N levels can indicate a first X number of frames, where X can be any number, of a content item to be processed. A third level can indicate a first time increment where the system 200 can process the first time increment's worth of a content item. The preload engine 214 can determine an amount of data to preload using data indicating interactions of a user (such as scroll speed) or device conditions (such as network conditions). In some cases, for slower scrolling and faster networks, the system 200 can preload more data that faster scrolling on slower networks.

The preload engine 214 can determine when to preload data for one or more content items, e.g., based on an estimated watch duration, network speed, initial preloading segment size, or a combination of these factors among others. Initial preloading segment size can refer to the segment size determined by the preload engine 214 as described herein. In some cases, the preload engine 214 can use one or more machine learning models to estimate an amount of time a user will continue to consume current content, such as an amount of time a user will continue to watch a currently watched video. The preload engine 214 might estimate watch time as forty seconds. The preload engine 214 can determine a remaining play time by determining a difference between a current watch length and the estimated watch time for the given current content item. In some cases, the preload engine 214 can determine a safety parameter indicating whether it is safe to preload a given content item. The preload engine 214 can use an indication of bandwidth, such as network or processing bandwidth, to determine the safety parameter. In some cases, the preload engine 214 can determine a result of an expression, such as

$$min ( remainPlayTime , preloadSize * \frac{8}{bandwidth} * 1000 ) ,$$

to represent the safety parameter, where the remainPlayTime represents a difference between the current watch length and the estimated watch time for the given current content item and the preloadSize is a previously determined amount of data to preload for the given content item, and bandwidth is an indication of processing or network bandwidth. The result of the expression can generate an indication of whether or not to preload. In general, if actual buffer required for subsequent content is large, preloading can be more likely to occur, e.g., if a measure of buffer is greater than or equal to the safety parameter the preload engine 214 can preload the given content item. Similarly, if a remaining play time is short, an amount of a subsequent content item to be preloaded is small, or bandwidth is large, preloading can be more likely to occur. A short remaining play time can indicate that preloading should be performed in view of a likely eminent request for subsequent content item. A small amount of data to be preloaded can indicate that preloading will have a minimal effect on system and should therefore be performed without delay. A large bandwidth can indicate that preloading will not negatively affect system because there is sufficient bandwidth not to negatively impact other processes and the preloading may be more achieved more rapidly. In some cases, the preload engine 214 can perform one or more processes to determine whether to preload based on one or more of the mentioned data items. In some cases, the processes include comparing a value indicating remaining play time, preload size, and bandwidth, such as the safety parameter with a value indicating a buffer requirement. Preloading can occur based on a comparison of these values which can account for the above considerations, e.g., to more likely load content if only a small amount is required, remaining play time of a preceding content item is short, or available bandwidth is large.

In some cases, the preload engine 214 can use one or more models that are trained on ground truth data indicating one or more characteristics describing a context of a device or an account of the device and a corresponding watch time, also referred to as consumption time for other types of content, for one or more videos. The one or more models can predict watch times for the one or more videos. The system 200 can adjust the one or more models based on a difference value between the predicted watch times for the one or more videos and the actual watch times. The final trained models can be used by the preload engine 214 to estimate watch times. e.g., to determine if or when to preload data for a content item.

The predemux engine 218 can obtain the preloaded content 216 generated by the preload engine 214. The preload engine 214 can provide the preloaded content 216 to the predemux engine 218. The predemux engine 218 can generate the demuxed content 220 using the context data 211. The predemux engine 218 can perform one or more data parsing operations on content, e.g., converting preloaded or cached data into video/audio frames.

In some cases, the predemux engine 218 can perform initial stages of prerendering. Demultiplexing can be an initial part of traditional prerendering operations. By separately determining predemux and prerendering, the system 200 can help reduce frame drops or other performance issues, especially for devices with bandwidth constraints, either from limited hardware capabilities or from concurrent processing loads. Instead of either prerendering or not, the system 200 can increase the granularity of the decision and reduce content latency in cases where context indicates full prerendering is not suitable or possible but predemux is suitable or possible.

In some cases, the predemux engine 218 is used only for certain device models or devices with certain processing loads. For example, the preprocessing engine 208 can determine whether or not to use the predemux engine 218 separately from the prerender engine 222. The preprocessing engine 208 can determine to use the predemux engine 218 separately from the prerender engine 222 to reduce an impact on processing bandwidth. e.g., either because a device model does not have sufficient available bandwidth due to hardware limitations, such as limited random access memory or slow central processing unit, or due to concurrent processes, such as other content preprocessing stages being performed for other content items or other device processes.

Even in cases where the user device 202 includes high end hardware, processing load for content playback at the start of playback might be high. The preprocessing engine 208 can separate predemux and prerender operations into two actions separated in time, e.g., to lighten a processing load. The separate predemux and prerender operations can be performed by the predemux engine 218 and the prerender engine 222, respectively. In some cases, based on user behavior, the preprocessing engine 208 can determine whether or not to separately schedule and perform predemux operations.

The prerender engine 222 generates the pre-processed content 224. In some cases, the prerender engine 222 starts a new player instance to handle data for a next content item to be provided to the user device 202. However, for devices with limited processing bandwidth either via hardware or concurrent processes, such prerendering can impose a significant load and noticeably affect a performance of currently accessed content, resulting in frame drops and other issues. To optimize between content latency and device capacity: the preprocessing engine 208 can determine whether or not to separately schedule and perform predemux operations. Predemux can include a degradation of prerender. Predemux can allow for an intermediate effect, e.g., processing data of next content as early as possible within an acceptable device load. By splitting a prerender process into demux and rendering stages, the preprocessing engine 208 can control prerender to distribute different data parsing actions across time. In this way, the preprocessing engine 208 can help mitigate performance degradation, such as frame drops, caused by high loads at specific moments, such as a start of a playback of content.

Due to the high load associated with rendering and displaying a first portion of content, such as a first frame, in some cases the prerender engine 222 can limit the number of content items that are prerendered to 1. The number of content items that are predemuxed can be dynamically adjusted based on various factors. For example, the predemux engine 218 can adjust a number of items to predemux based on user behavior and a device score parameter. If the predemux engine 218 detects performance issues, such as UI frame drops or content frame drops, the predemux engine 218 can reduce the number of content items to be predemuxed to a minimum value, such as 1. In some cases, the predemux engine 218 can detect performance issues using a frame rate assessment, e.g., detecting one or more frames expected to be provided via the user device 202 compared to one or more frames actually provided to the user device 202. Frame rate assessment can be completed by collecting frame rate data in player rendering module.

In some cases, the preprocessing engine 208 can perform one or more operations to control operations of the predemux engine 218 and the prerender engine 222, such as one or more operations described in the following pseudocode:

```
Params:
default_predemux_count,
max_predemux_count,
min_predemux_count,
Input:
sliding_label,
device_score,
has_frame_dropping,
Logic:
predemux_count = default_predemux_count
if device_label < 6.6:
  # low-end device
  predemux_count −= 1
if sliding_label == 1:
  # quick sliding
  predemux_count += 1
if has_frame_dropping:
  predemux_count = min_predemux_count
predemux_count = min(max(predemux_count, min_predemux_count),
max_predemux_count)
```

Parameters in the above pseudocode can be dynamically adjusted via processes or manual tuning. Input can be obtained from user operations, system application program interfaces, data statistics, or a combination of these among others. The preprocessing engine 208 can perform operations that include determining that a device performance score satisfies a performance threshold for a low-performance device (such as below 6.6 in the above pseudocode). In response to determining a performance score satisfies a performance threshold, the preprocessing engine 208 can adjust a count of items for predemux, e.g., reducing predemux_count. The preprocessing engine 208 can determine whether or not a user interface indicates a user is sliding, swiping, or performing another content retrieval interface action at a rate that satisfies a threshold. e.g., indicating a user is sliding fast. In response to the determination, the preprocessing engine 208 can adjust a count of items for predemux, e.g., further reducing predemux_count. The preprocessing engine 208 can determine whether or not frame dropping occurs. In response to the determination, the preprocessing engine 208 can adjust a count of items for predemux, e.g., reducing predemux_count to a lowest threshold min_predemux_count. The preprocessing engine 208 can perform operations that limit the predemux_count to within a range that includes min_predemux_count to max_predemux_count.

As the playback duration increases, a series of preprocessing actions within a current player can be completed before the current playback ends. This can result in a decrease in overall load as processing load tends to be highest at the start of playback. In some cases, the impact of increased load on playback performance from delaying predemux or prerender operations on subsequent content is reduced. In some cases, with the additional available processing bandwidth, the preprocessing engine 208 can reduce the time for processing operations of predemux and prerender.

In some cases, the preprocessing engine 208 can mitigate lost resources when users navigate away from a subsequently scheduled content item that has been preprocessed before that content is provided for consumption. Resources, in this case, may be said to have been lost because the preprocessing is not utilized because the content is not consumed at the expected future time. The load curve of content playback in a set of content to be played can be represented by L (t) and a probability of a user exiting is represented by P (t). The initial load for predemux or prerender can be represented by A, and the load maintenance coefficient can be represented by γ. If the next content item to be played does not have predemux or prerender for a first frame, a penalty can be represented by a. The preprocessing engine 208 can determine a result using these parameters to determine whether or when to perform predemux or prerender. For example. For example, the preprocessing engine 208 can determine a result of an expression, such as:

$$- α * ( 1 - P ( t > T ) ) - P ( t > T ) * [ λ + L ( T ) + {\int }_{T}^{D} γ ( t - T ) P ( t ) dt ] .$$

The output of the expression can be referred to as F(T).

α*(1−P (t>T)) can represent an expected penalty for a next content item if a user exits before time T and there is no predemux or prerender for the first frame. The second term can represent an expected additional load incurred by performing predemux or prerender before a user scrolls away at time T. Since the initial load λ, load maintenance coefficient γ, and first frame penalty a can differ for predemux and prerender, the calculated results can also vary. For example. For example, the preprocessing engine 208 can perform the calculation for each content item for both predemux and prerender to determine whether to perform predemux or prerender. The preprocessing engine 208 can compare F(T) for predemux and F(T) for prerender. In some cases, based on the comparison showing F(T) for predemux is larger than F(T) for prerender, the preprocessing engine 208 can perform predemux separately from prerender. In some cases, based on the comparison showing F(T) for predemux is equal to F(T) for prerender, the preprocessing engine 208 can perform a default action, such as prerender.

Item 226 graphically shows a result of the preprocessing engine 208. For example. For example, for each of four content items, the preprocessing engine 208 can determine timing. In some cases, the preprocessing engine 208 can determine to perform preprocessing operations on four content items during a playback of a fifth, different, content item. In some cases, the preprocessing engine 208 can determine to add content items for preprocessing iteratively as time passes, e.g., adding two content items for preprocessing during a current playback then adding two additional content items for preprocessing during subsequent content playback. In general, determinations of if or when to perform preprocessing stages can be made during any content playback. The preprocessing engine 208 can determine to perform preprocessing for any number of content items, e.g., where additional preprocessing can be dependent upon available processing bandwidth.

The system 100 and 200 are examples of systems that can be implemented as computer programs on one or more computers in one or more locations, in which the systems, components, and techniques described in this specification are implemented. The user devices 102 and 202 can include personal computers, mobile communication devices, and other devices that can send and receive data over a network. The network (not shown), such as a local area network (“LAN”), wide area network (“WAN”), the Internet, or a combination thereof, can connect the user devices with other elements of the systems. The systems 100 and 200 can use a single computer or multiple computers operating in conjunction with one another, including, for example, a set of remote computers deployed as a cloud computing service.

The systems 100 and 200 can include several different functional components, including component engines that operate on the platforms 106 and 204. The functional components can include one or more data processing apparatuses, can be implemented in code, or a combination of both. For instance, each of the components can include one or more data processors and instructions that cause the one or more data processors to perform the operations discussed herein.

The various functional components of the systems 100 and 200 can be installed on one or more computers as separate functional components or as different modules of a same functional component. For example, the components of the systems 100 and 200 can be implemented as computer programs installed on one or more computers in one or more locations that are coupled to each through a network. In cloud-based systems for example, these components can be implemented by individual computing nodes of a distributed computing system.

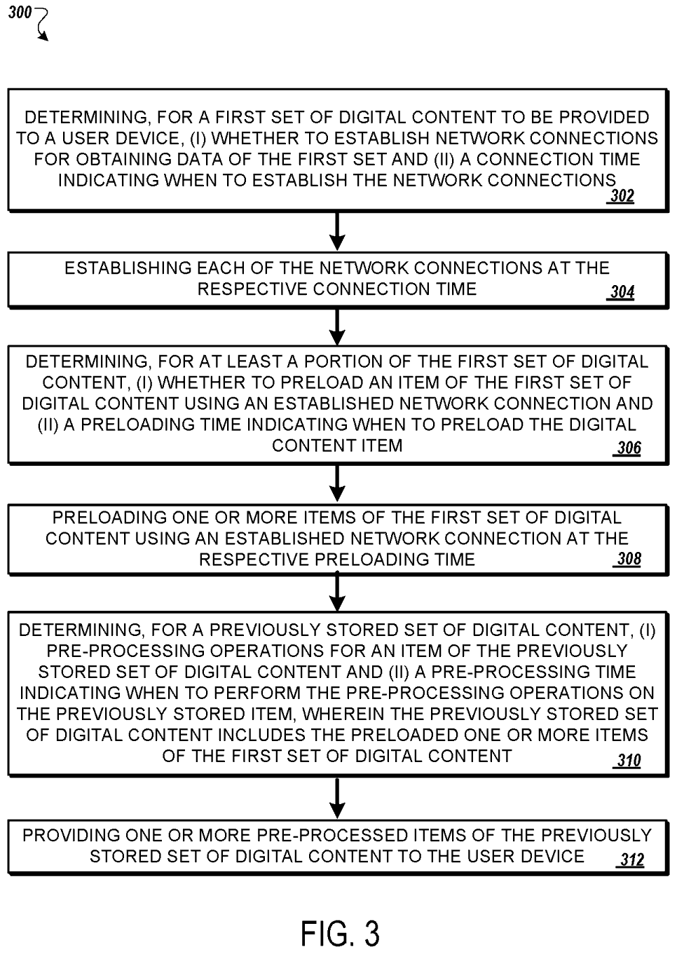

FIG. 3 is a flowchart of an example process 300 for content preprocessing. For convenience, the process 300 will be described as being performed by a system of one or more computers, located in one or more locations, and programmed appropriately in accordance with this specification. For example, the system 100 of FIG. 1 or the system 200 of FIG. 2, appropriately programmed, can perform the process 300.

The process 300 includes determining, for a first set of digital content to be provided to a user device. (i) whether to establish network connections for obtaining data of the first set and (ii) a connection time indicating when to establish the network connections (302). For example, the preio engine 210 of the system 200 can be configured to establish network connections 212.

The process 300 includes establishing each of the network connections at the respective connection time (304). For example, the preio engine 210 can check one or more conditions and, in response to the one or more conditions being satisfied, the preio engine 210 can establish one or more network connections. A connection time can start, e.g., at a time of the preio engine 210 checking and determining one or more conditions are satisfied. A connection time can start at a time after such a determination.

In some cases, establishing each of the network connections at the respective connection time includes establishing a data transfer channel between the user device and a data source, where the data source includes a portion of the first set of digital content. For example, the preio engine 210 can establish a channel between the user device 202 and a data source, e.g., of the platform 204.

The process 300 includes determining, for at least a portion of the first set of digital content. (i) whether to preload an item of the first set of digital content using an established network connection and (ii) a preloading time indicating when to preload the digital content item (306). For example, the preload engine 214 uses the network connections 212 to preload content and generate the preloaded content 216.

The process 300 includes preloading one or more items of the first set of digital content using an established network connection at the respective preloading time (308). For example, the preload engine 214 can check one or more conditions and, in response to the one or more conditions being satisfied, the preload engine 214 can preload one or more items. Items can be preloaded, e.g., at a time of the preload engine 214 checking and determining one or more conditions are satisfied. Items can be preloaded at a time after such a determination.

In some cases, preloading one or more items of the first set of digital content at the respective preloading time includes storing header data of the first set of digital content in memory of the user device. In some cases, preloading one or more items of the first set of digital content at the respective preloading time includes storing a first frame of data from the first set of digital content in memory of the user device. In some cases, preloading one or more items of the first set of digital content at the respective preloading time includes storing a first set of data frames from the first set of digital content in memory of the user device. For example, the preload engine 214 can preload any element of any digital content being pre-processed.

The process 300 includes determining, for a previously stored set of digital content. (i) pre-processing operations for an item of the previously stored set of digital content and (ii) a pre-processing time indicating when to perform the pre-processing operations on the previously stored item, wherein the previously stored set of digital content includes the preloaded one or more items of the first set of digital content (310). For example, the preprocessing engine 208 can determine pre-processing operations and a pre-processing time. Based on a determination, the preprocessing engine 208 can use the predemux engine 218, the prerender engine 222, or a combination of these to pre-process digital content.

In some cases, determining (i) the pre-processing operations for an item of the previously stored set of digital content or (ii) a pre-processing time indicating when to perform the pre-processing operations on the previously stored item includes determining whether to perform predemuxing separate from prerendering. Determining whether to perform predemuxing separate from prerendering can include obtaining context data; and determining, using the context data, whether to perform predemuxing separate from prerendering. Obtaining the context data can include obtaining an indication of processing bandwidth of the user device, and where determining whether to perform predemuxing separate from prerendering can include determining, using the indication of processing bandwidth of the user device, whether to perform predemuxing separate from prerendering.

The process 300 includes providing one or more pre-processed items of the previously stored set of digital content to the user device (312). For example, the preprocessing engine 208 can provide the pre-processed content 224 to the user device 202.

In some cases, determining one or more of the network connections, preloading of the one or more items, or the pre-processing operations include obtaining data indicating user behavior; and determining, using the obtained data, one or more actions. Obtaining the data indicating user behavior can include obtaining data indicating a rate of content requests by the device, and where determining the one or more actions can include determining, using the obtained data indicating the rate of content requests, to establish the network connections. Obtaining the data indicating the rate of content requests by the device can include obtaining data indicating a swipe speed of a user controlling the device. Determining to establish the network connections using the obtained data indicating the rate of content requests can include determining a first amount of network connections for data indicating a first rate of content requests and a second amount of network connections for data indicating a second rate of content requests, where the first amount of network connections is greater than the second amount of network connections, and where the first rate of content requests is greater than the second rate of content requests.

In some cases, the process 300 includes determining an estimated consumption time of content playing on the user device, where determining (i) whether to preload an item of the first set of digital content using an established network connection or (ii) a preloading time indicating when to preload the digital content item include comparing the estimated consumption time with a remaining consumption time; and determining, using the comparison. (i) whether to preload an item of the first set of digital content using an established network connection or (ii) a preloading time indicating when to preload the digital content item. For example, the preprocessing engine 208 can periodically run code to check whether conditions, such as preloading conditions, have been satisfied (e.g., satisfying one or more thresholds). In response to one or more conditions being satisfied, the preprocessing engine 208 can perform an action, e.g., preloading content in response to preloading conditions satisfying one or more thresholds. The timing of actions can in a subsequent compute cycle following a determination that conditions have been satisfied or after an amount of delay time from such a determination.

The order of operations in the process 300 described above is illustrative only, and can be performed in different orders in some cases. In some implementations, the process 300 can include additional operations, fewer operations, or some of the operations can be divided into multiple operations.

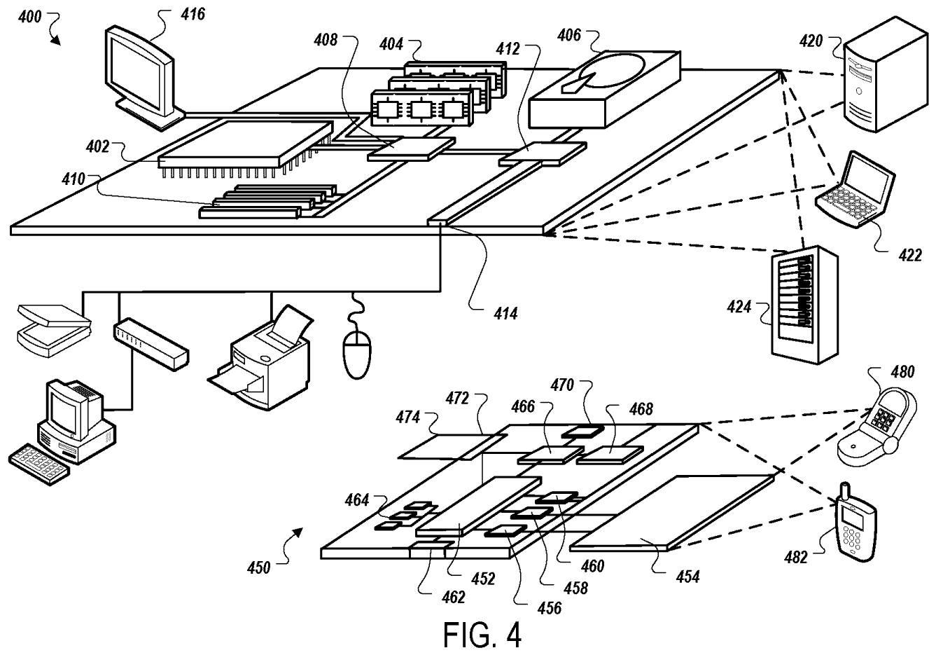

FIG. 4 is a block diagram of a computing system that can be used in connection with computer-implemented methods described in this specification. The computing system includes computing device 400 and a mobile computing device 450 that can be used to implement the techniques described herein. For example, one or more components of the system 100 or 200 could be an example of the computing device 400 or the mobile computing device 450.

The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 402 is a single threaded processor. In some implementations, the processor 402 is a multi-threaded processor. In some implementations, the processor 402 is a quantum computer.

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine-readable mediums (for example, the memory 404, the storage device 406, or memory on the processor 402). The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB. Bluetooth. Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may include one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry in some cases. The communication interface 466 may provide for communications under various modes or protocols, such as GSM voice calls (Global System for Mobile communications). SMS (Short Message Service). EMS (Enhanced Messaging Service), or MMS messaging (Multimedia Messaging Service). CDMA (code division multiple access). TDMA (time division multiple access). PDC (Personal Digital Cellular). WCDMA (Wideband Code Division Multiple Access). CDMA2000, or GPRS (General Packet Radio Service). LTE. 4G/6G cellular, among others. Such communication may occur, for example, through the transceiver 468 using a radio frequency. In addition, short-range communication may occur, such as using a Bluetooth. Wi-Fi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, among others) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

In general, use of “or” can refer to “and/or.” When providing a list of two or more items, the conjunction “or” can indicate any one of the items, any combination of a subset of the items, or all items in combination.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine: in other cases, multiple engines can be installed and running on the same computer or computers.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may: but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display: for displaying information to the user, and an input device by which the user can provide input to the computer, e.g., a keyboard and a pointing device, e.g., a mouse, a trackball or touchpad. Other kinds of devices can be used to provide for interaction with a user as well: for example, feedback and responses provided to the user can be any form of sensory feedback, e.g., visual, auditory: speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user: for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

I/We claim:

1. A method comprising:
determining, for a first set of digital content to be provided to a user device, (i) whether to establish network connections for obtaining data of the first set and (ii) a connection time indicating when to establish the network connections;
establishing each of the network connections at the respective connection time;
determining, for at least a portion of the first set of digital content, (i) whether to preload an item of the first set of digital content using an established network connection and (ii) a preloading time indicating when to preload the digital content item;
preloading one or more items of the first set of digital content using an established network connection at the respective preloading time;
determining, for a previously stored set of digital content, (i) pre-processing operations for an item of the previously stored set of digital content and (ii) a pre-processing time indicating when to perform the pre-processing operations on the previously stored item, wherein the previously stored set of digital content includes the preloaded one or more items of the first set of digital content; and
providing one or more pre-processed items of the previously stored set of digital content to the user device.

2. The method of claim 1, wherein establishing each of the network connections at the respective connection time comprises:
establishing a data transfer channel between the user device and a data source, wherein the data source includes a portion of the first set of digital content.

3. The method of claim 1, wherein preloading one or more items of the first set of digital content at the respective preloading time comprises:
storing header data of the first set of digital content in memory of the user device.

4. The method of claim 1, wherein preloading one or more items of the first set of digital content at the respective preloading time comprises:
storing a first frame of data from the first set of digital content in memory of the user device.

5. The method of claim 1, wherein preloading one or more items of the first set of digital content at the respective preloading time comprises:
storing a first set of data frames from the first set of digital content in memory of the user device.

6. The method of claim 1, wherein determining one or more of the network connections, preloading of the one or more items, or the pre-processing operations comprises:
obtaining data indicating user behavior; and
determining, using the obtained data, one or more actions.

7. The method of claim 6, wherein obtaining the data indicating user behavior comprises:
obtaining data indicating a rate of content requests by the device, and wherein determining the one or more actions comprises:
determining, using the obtained data indicating the rate of content requests, to establish the network connections.

8. The method of claim 7, wherein obtaining the data indicating the rate of content requests by the device comprises:
obtaining data indicating a swipe speed of a user controlling the device.

9. The method of claim 7, wherein determining to establish the network connections using the obtained data indicating the rate of content requests comprises:
determining a first amount of network connections for data indicating a first rate of content requests and a second amount of network connections for data indicating a second rate of content requests, wherein the first amount of network connections is greater than the second amount of network connections, and wherein the first rate of content requests is greater than the second rate of content requests.

10. The method of claim 1, comprising:
determining an estimated consumption time of content playing on the user device, wherein determining (i) whether to preload an item of the first set of digital content using an established network connection or (ii) a preloading time indicating when to preload the digital content item comprises:
comparing the estimated consumption time with a remaining consumption time; and
determining, using the comparison, (i) whether to preload an item of the first set of digital content using an established network connection or (ii) a preloading time indicating when to preload the digital content item.

11. The method of claim 1, wherein determining (i) the pre-processing operations for an item of the previously stored set of digital content or (ii) a pre-processing time indicating when to perform the pre-processing operations on the previously stored item comprises:
determining whether to perform predemuxing separate from prerendering.

12. The method of claim 11, wherein determining whether to perform predemuxing separate from prerendering comprises:
obtaining context data; and
determining, using the context data, whether to perform predemuxing separate from prerendering.

13. The method of claim 12, wherein obtaining the context data comprises:
obtaining an indication of processing bandwidth of the user device, and wherein determining whether to perform predemuxing separate from prerendering comprises:
determining, using the indication of processing bandwidth of the user device, whether to perform predemuxing separate from prerendering.

14. One or more non-transitory computer storage media encoded with computer program instructions that when executed by one or more computers cause the one or more computers to perform operations comprising:
determining, for a first set of digital content to be provided to a user device, (i) whether to establish network connections for obtaining data of the first set and (ii) a connection time indicating when to establish the network connections;
establishing each of the network connections at the respective connection time;
determining, for at least a portion of the first set of digital content, (i) whether to preload an item of the first set of digital content using an established network connection and (ii) a preloading time indicating when to preload the digital content item;
preloading one or more items of the first set of digital content using an established network connection at the respective preloading time;
determining, for a previously stored set of digital content, (i) pre-processing operations for an item of the previously stored set of digital content and (ii) a pre-processing time indicating when to perform the pre-processing operations on the previously stored item, wherein the previously stored set of digital content includes the preloaded one or more items of the first set of digital content; and
providing one or more pre-processed items of the previously stored set of digital content to the user device.

15. The media of claim 14, wherein establishing each of the network connections at the respective connection time comprises:
establishing a data transfer channel between the user device and a data source, wherein the data source includes a portion of the first set of digital content.

16. The media of claim 14, wherein preloading one or more items of the first set of digital content at the respective preloading time comprises:
storing header data of the first set of digital content in memory of the user device.

17. The media of claim 14, wherein preloading one or more items of the first set of digital content at the respective preloading time comprises:
storing a first frame of data from the first set of digital content in memory of the user device.

18. The media of claim 14, wherein preloading one or more items of the first set of digital content at the respective preloading time comprises:
storing a first set of data frames from the first set of digital content in memory of the user device.

19. The media of claim 14, wherein determining one or more of the network connections, preloading of the one or more items, or the pre-processing operations comprises:
obtaining data indicating user behavior; and
determining, using the obtained data, one or more actions.

20. A system comprising:
one or more computers and one or more storage devices on which are stored instructions that are operable, when executed by the one or more computers, to cause the one or more computers to perform operations comprising:
determining, for a first set of digital content to be provided to a user device, (i) whether to establish network connections for obtaining data of the first set and (ii) a connection time indicating when to establish the network connections;
establishing each of the network connections at the respective connection time;
determining, for at least a portion of the first set of digital content, (i) whether to preload an item of the first set of digital content using an established network connection and (ii) a preloading time indicating when to preload the digital content item;
preloading one or more items of the first set of digital content using an established network connection at the respective preloading time;
determining, for a previously stored set of digital content, (i) pre-processing operations for an item of the previously stored set of digital content and (ii) a pre-processing time indicating when to perform the pre-processing operations on the previously stored item, wherein the previously stored set of digital content includes the preloaded one or more items of the first set of digital content; and
providing one or more pre-processed items of the previously stored set of digital content to the user device.
